(19) United States
(12) Patent Application Publication
(10) Pub. No.: US 2006/0081291 A1
(43) Pub. Date: Apr. 20, 2006

(54) Central vacuum cleaner wall valve, hose nipple, and cleaning system

(75) Inventor: J. Vem Cunningham, Aurora (CA)

Correspondence Address: Ralph A. Dowell of DOWELL & DOWELL P.C., 2111 Eisenhower Ave, Suite 406, Alexandria, VA, 22314, US

(73) Assignee: Cube Investments Limited

(21) Appl. No.: 11/220,714

(22) Filed: Sep. 8, 2005

Related U.S. Application Data
(63) Continuation-in-part of application No. 10/936,699, filed on Sep. 9, 2004.

(51) Int. Cl. F16L 5/00

(52) U.S. Cl. 137/360

(57) ABSTRACT

Hose nipple has longitudinal axis, distal end, and aperture. Distal end closed and in line with axis for insertion into wall valve. Aperture opens out of line with axis. Nipple and valve alignment mechanisms align nipple and valve apertures for mating. Valve member slides in valve on insertion of nipple through opening of valve against front surface of member. In first position, front surface between opening and aperture. Fluid connection through valve prevented. In second position, front surface further into valve, and fluid connection provided. Valve and nipple longitudinal retention mechanisms retain nipple. Mechanisms engaged by rotational movement. Valve and nipple rotational coupling mechanisms form rotational coupling that is manually engageable and releasable. Hose assembly has nipple, handle, and stretch hose. Handle may have turbine and generator, air causes turbine to turn and generator to generate electrical energy. Central vacuum cleaning system has vacuum source, valve, piping, and assembly.

### CROSS-REFERENCE TO RELATED APPLICATIONS

This is a continuation-in-part of U.S. patent application Ser. No. 10/936,699 entitled CENTRAL VACUUM CLEANING SYSTEM CONTROL SUBSYSTEMS filed Sep. 9, 2004, the content of which is hereby incorporated by reference into the detailed description hereof.

### FIELD OF THE INVENTION

The invention relates to central vacuum cleaning systems. More particularly it relates to wall valves and hose nipples for such systems.

### BACKGROUND OF THE INVENTION

Central vacuum cleaning systems were originally quite simple. One placed a powerful central vacuum source external to the main living space. The source was connected through interior walls to a long flexible hose that terminated in a handle and nozzle. When an operator desired to use the system, the operator went to the source and turned it on. The operator then went inside, picked up the handle and directed the nozzle to an area to be cleaned.

Although many elements of the basic system remain, many improvements have been made. Rigid pipes typically run inside interior walls to numerous wall valves spaced throughout a building. This allows an operator to utilize a smaller hose while covering an equivalent space. This is an advantage as the hose can be quite bulky and heavy.

Various communication systems have been developed. Some systems sense sound or pressure in the pipes to turn the vacuum source on or off, see for example U.S. Pat. No. 5,924,164 issued Jul. 20, 1999 to Edward W. Lindsay under title ACOUSTIC COMMUNICATOR FOR CENTRAL VACUUM CLEANERS. Other systems run low voltage wires between the source and the wall valve. The source can be turned on and off at a wall valve by a switch that may be activated by insertion or removal of the hose. The hose may also contain low voltage wires to allow the source to be controlled from a switch in the handle, see for example U.S. Pat. No. 5,343,590 issued Sep. 6, 1994 to Kurtis R. Radabaugh under title LOW VOLTAGE CENTRAL VACUUM CONTROL HANDLE WITH AN AIR FLOW SENSOR. The switch can be a simple toggle switch, or a more sophisticated capacitive switch.

The low voltage wires running along the pipes can be replaced by conductive tape or the like on the pipes, see for example U.S. Pat. No. 4,854,887 issued Aug. 8, 1989 to Jean-Claude Blandin under title PIPE SYSTEM FOR CENTRAL SUCTION CLEANING INSTALLATION. Separate low voltage conductors in the walls can be avoided altogether by using mains power wires to transmit communication signals between the wall valve and the source, see for example U.S. Pat. No. 5,274,878 issued Jan. 4, 1994 to Kurtis R. Radabaugh et al under title REMOTE CONTROL SYSTEM FOR CENTRAL VACUUM SYSTEMS. A handheld radio frequency wireless transmitter can be used by an operator to turn the source on or off, see for example U.S. Pat. No. 3,626,545 issued Dec. 14, 1971 to Perry W. Sparrow under title CENTRAL VACUUM CLEANER WITH REMOTE CONTROL.

Line voltage can be brought adjacent the vacuum wall valves and connected to the handle through separate conductors, or integrated spiral wound conductors on the hose. Line voltage can then be brought from the handle to powered accessories, such as an electrically-powered beater bar, connected to the nozzle. Line voltage can be switched on and off to the powered accessory using the same switch in the handle that controls the source. Alternatively, the powered accessory may have its own power switch.

Improvements to, or additional or alternative features for, central vacuum cleaning systems are desirable.

### SUMMARY OF THE INVENTION

In a first aspect the invention provides a vacuum wall valve for use in association with a vacuum hose assembly having a hose nipple. The vacuum wall valve has an opening for receiving the hose nipple, a valve member having a front surface, and an aperture. The valve member is adapted for movement in the wall valve between a first position and a second position in response to insertion of the hose nipple through the opening and against the front surface. In the first position, the front surface is between the opening and the aperture. The front surface substantially encloses the opening. Fluid connection between the opening and the aperture through the wall valve is prevented by the valve member. In the second position, the front surface is further into the wall valve in relation to the opening. Fluid connection is provided through the wall valve between the opening and the aperture.

The valve member may be adapted for movement by sliding between the first position and the second position.

The valve member may have a sealing surface. The sealing surface seals about the valve aperture to prevent fluid connection between the opening and the aperture when the valve member is in the first position. The sealing surface is positioned away from the aperture to permit fluid connection between the opening and the aperture when the valve member is in the second position.

The hose nipple with which the valve is to be used may have a longitudinal axis and an aperture in the hose nipple that opens out of line with the hose nipple longitudinal axis. If so, the valve aperture may be positioned to mate with the hose nipple aperture to provide sealed fluid communication between the valve aperture and the hose nipple.

The valve aperture may open generally perpendicular to the valve longitudinal axis.

The vacuum wall valve may have a valve alignment mechanism for receiving a corresponding nipple alignment mechanism on the hose nipple with which the valve is to be used. The alignment mechanisms in combination align the hose nipple aperture and the valve aperture for mating.

The vacuum wall valve may have a first longitudinal retention mechanism for receiving a corresponding second longitudinal retention mechanism on the hose nipple. The retention mechanisms in combination releasably retain the hose nipple in the wall valve against longitudinal movement during use. The retention mechanisms may be engaged by rotational movement.

The retention mechanisms may be corresponding flanges.

The wall valve may have a first rotational coupling mechanism for engagement with a second rotational coupling mechanism on the hose nipple. Engagement of the first rotational coupling mechanism and the second rotational coupling mechanism form a rotational coupling between the valve and hose nipple. The rotational coupling is manually engageable and manually releasable.

The wall valve may have a first rotational alignment mechanism for alignment with a second rotational alignment mechanism on the hose nipple. The first rotational alignment mechanism and the second rotational alignment mechanism may be used to align the hose nipple aperture and the valve aperture.

The valve alignment mechanism may have a first valve alignment mechanism on the front surface.

The wall valve may have a generally tubular conduit with the opening in one end of the conduit and an opposing end of the conduit closed. The aperture opens through the conduit but not at either of the ends, and the valve member is adapted for movement in the wall valve by sliding within the conduit, and the first position and the second position are within the conduit.

The wall valve may have a generally tubular conduit with the opening in one end of the conduit and an opposing end of the conduit closed. The aperture opens through the conduit but not at either of the ends, the valve member is adapted for movement in the wall valve by sliding within the conduit, and the first position and the second position are within the conduit, and the valve alignment mechanism may have a first valve alignment mechanism on the front surface, and the nipple alignment mechanism may be on the hose nipple.

The valve member and the conduit may be adapted to permit rotation of the valve member within the conduit such that the valve aperture and the hose nipple aperture may be rotationally aligned.

The valve alignment mechanism may have a first alignment mechanism on the front surface of the valve member corresponding to the nipple alignment mechanism, and a second alignment mechanism on the valve member and a corresponding third alignment mechanism on the conduit. In this case, the nipple alignment mechanism and the first alignment mechanism may in combination rotationally align the hose nipple and the valve member, and the second alignment mechanism and the third alignment mechanism may in combination rotationally align the valve member and the conduit, such that the valve aperture and the hose nipple aperture are rotationally aligned.

The second and third alignment mechanisms may have a positive indication of rotational alignment of the valve aperture and the hose nipple aperture.

The second and third alignment mechanisms may have a locking arrangement to prevent undesired rotation of the valve aperture and the hose nipple aperture once the apertures are aligned.

In a second aspect the invention provides a central vacuum cleaning system hose nipple for use in association with a central vacuum cleaning system wall valve. The hose nipple has a longitudinal axis, a distal end, and an aperture. The distal end is closed and in line with the longitudinal axis. The distal end is for insertion into the wall valve. The aperture opens out of line with the longitudinal axis.

The hose nipple may have a first alignment mechanism for insertion against a corresponding second alignment mechanism on the wall valve with which the hose nipple is to be used. The alignment mechanisms in combination align the hose nipple aperture and a wall valve aperture on the wall valve for mating.

In a third aspect the invention provides a central vacuum cleaning system hose assembly for use in association with a wall valve having a first longitudinal retention mechanism. The hose assembly has a hose nipple, hose handle, and a hose. The hose nipple is connected to a first end of the hose and the hose handle is connected to an opposing second end of the hose. The hose is a stretch hose. The hose nipple has a second longitudinal retention mechanism for mating with the first longitudinal retention mechanism to releasably retain the hose nipple in the wall valve against longitudinal movement during use.

The stretch hose may be wireless and the handle may have a radio frequency wireless transmitter.

The handle may have a turbine and a generator. The turbine is located such that air moving through the cleaning system during use will cause the turbine to turn. Turning of the turbine causes the generator to generate electrical energy.

In a fourth aspect the invention provides a central vacuum cleaning system having a central vacuum source, a wall valve, piping providing fluid communication between the wall valve and the vacuum source. The wall valve comprises an opening for receiving the hose nipple, a valve member having a front surface, and an aperture. The valve member is adapted for movement in the wall valve between a first position and a second position in response to insertion of the hose nipple through the opening and against the front surface. In the first position, the front surface is between the opening and the aperture, the front surface substantially encloses the opening, and fluid connection between the opening and the aperture through the wall valve is prevented by the valve member. In the second position, the front surface is further into the wall valve in relation to the opening, and fluid connection is provided through the wall valve between the opening and the aperture.

In a fifth aspect the invention provides a central vacuum cleaning system having a central vacuum source, a wall valve having an opening, piping providing fluid communication between the wall valve and the vacuum source, and a hose assembly. The wall valve comprises a first longitudinal retention mechanism. The hose assembly has a hose, a hose nipple at one end of the hose, and a handle at another end of the hose. The hose is a stretch hose. The hose nipple has a second longitudinal retention mechanism. The first longitudinal retention mechanism is for receiving the second longitudinal retention mechanism upon mating of the hose nipple and wall valve. The retention mechanisms in combination releasably retain the hose nipple in the opening of the wall valve against longitudinal movement during use of the cleaning system for cleaning.

Other aspects of the invention, including for example, methods of use of the aspects described above, will be evidence from the principles described herein including those contained in the detailed description and the FIGS following below.

### BRIEF DESCRIPTION OF THE DRAWINGS

For a better understanding of the present invention and to show more were clearly how it may be carried into effect, reference will now be made, by way of example, to the accompanying drawings which show the preferred embodiment of the present invention and in which:

FIG. 1 is a side cross-section view of a central vacuum cleaning system wall valve in a closed position, the wall valve installed in a wall cavity with a central vacuum cleaning system wall pipe and the wall valve in use with a vacuum cleaning system hose nipple, all in accordance with a preferred embodiment of the present invention;

FIG. 2 is a side cross-section view of the wall valve, cavity, pipe and hose nipple of FIG. 1 with the wall valve in an open position;

FIG. 3 is a side cross-section view of a building incorporating a central vacuum cleaning system including the wall valve, cavity, pipe and hose nipple of FIGS. 1 and 2;

FIG. 4 is an exploded perspective view of the wall valve and hose nipple of FIGS. 1 and 2;

FIG. 5 is an exploded side elevation view of the wall valve and hose nipple of FIGS. 1 and 2;

FIG. 6 is a side elevation view of the wall valve, cavity, pipe and hose nipple of FIGS. 1 and 2 in the position of FIG. 1;

FIG. 7 is a side perspective view of the wall valve, cavity, pipe and hose nipple of FIGS. 1 and 2 in the position of FIG. 2;

FIG. 8A is a front elevation view of a portion of the wall valve of FIGS. 1 and 2 in the position of FIG. 1;

FIG. 8B is a rear perspective view of a conduit used in the wall valve of FIGS. 1 and 2;

FIG. 9 is a longitudinal cross-section of a portion of a hose assembly incorporating the hose nipple of FIGS. 1 and 2, a stretch hose and non-stretch storage conduit;

FIG. 10 is a schematic diagram of a RF wireless control subsystem for use in a central vacuum cleaning system such as the central vacuum cleaning system of FIG. 3;

FIG. 11 is a side view of a handle incorporating a portion of the RF wireless control subsystem of FIG. 10;

FIG. 12 is a side cross-section view of an embodiment of the handle shown in FIG. 11;

FIG. 13 is a perspective view of a turbine-driven attachment for use in a central vacuum cleaning system such as the system of FIG. 3; and

FIG. 14 is a partial cut-away perspective view of an electrically-powered attachment for use in a central vacuum cleaning system such as the system of FIG. 3.

### DETAILED DESCRIPTION OF THE PREFERRED EMBODIMENT

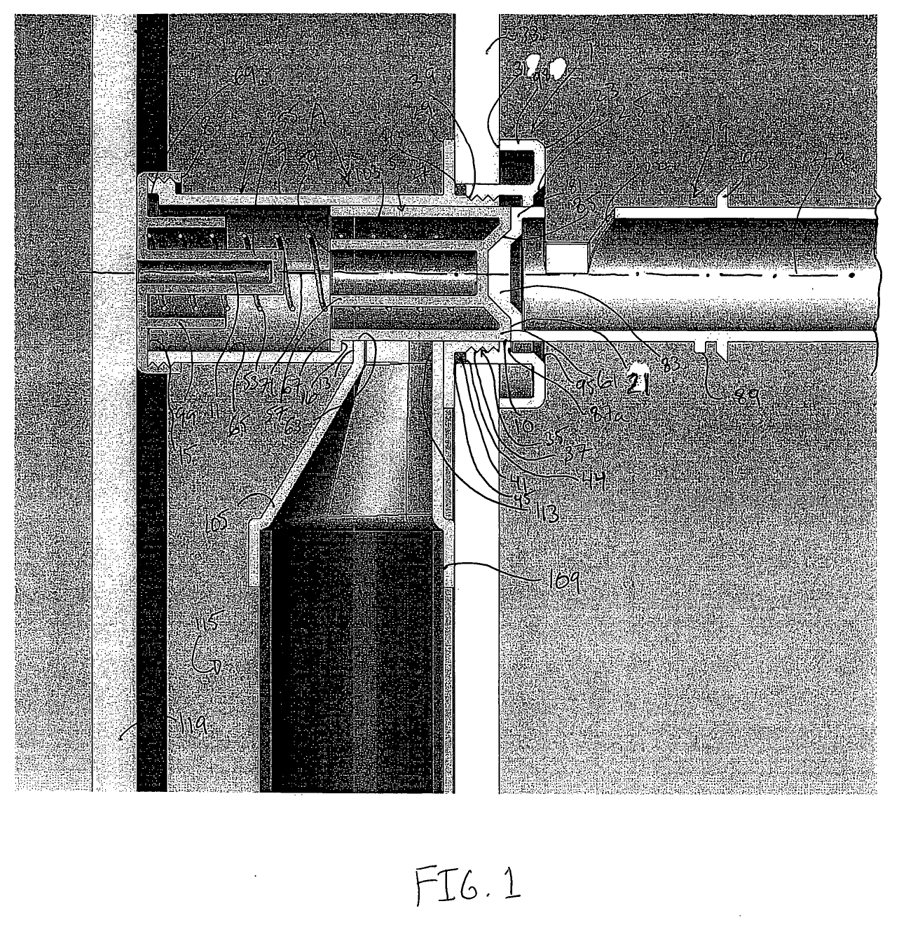

Referring to FIG. 1, a vacuum cleaner wall valve 1 has a housing 3 that houses a valve member 5. The housing 3 has a rigid conduit 7 terminating at one end in a closed end cap 8. At an opposing end 9 the conduit 7 has an opening 10. The conduit 7 has a longitudinal axis 11. The conduit 7 has an aperture 13 that opens through the conduit 7 out of line with the axis 11. In the preferred embodiment the aperture 13 opens generally perpendicular to the axis 11.

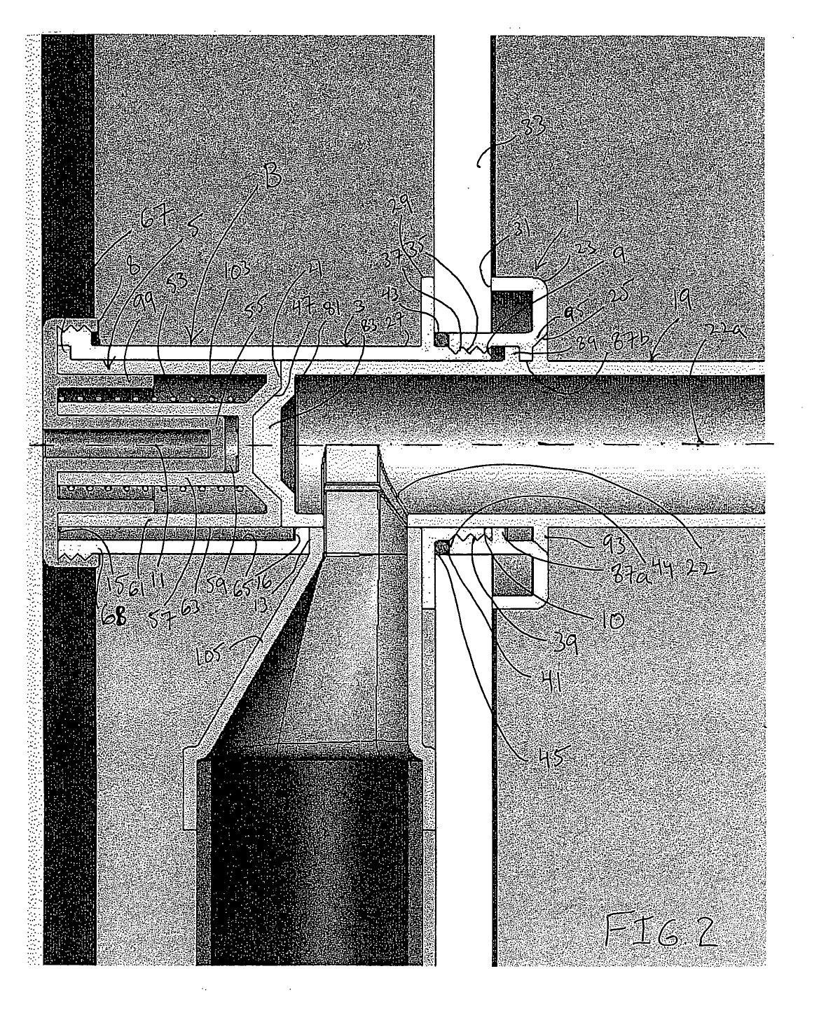

Referring to FIGS. 1 and 2, the valve member 5 is movable within the conduit 7 along the axis 11. In a first closed position A as shown in FIG. 1, the valve member 5 seals the aperture 13, while in a second open position B, as shown in FIG. 2, the valve member does not seal the aperture 13. The valve member 5 slides within the conduit between position A and position B. The valve member 5 moves further into the wall valve 1 in relation to the opening 10 when moving from the closed position A to the open position B. This is contrary to currently available wall valves that have a spring loaded door that opens away from the wall valve.

The end cap 8 provides a first stop surface 15 for the valve member 5 to define the longitudinal position along the axis 11 of position A. The conduit 7 provides a second stop surface 16 for the valve member 5 to define the longitudinal position along the axis 11 of position B.

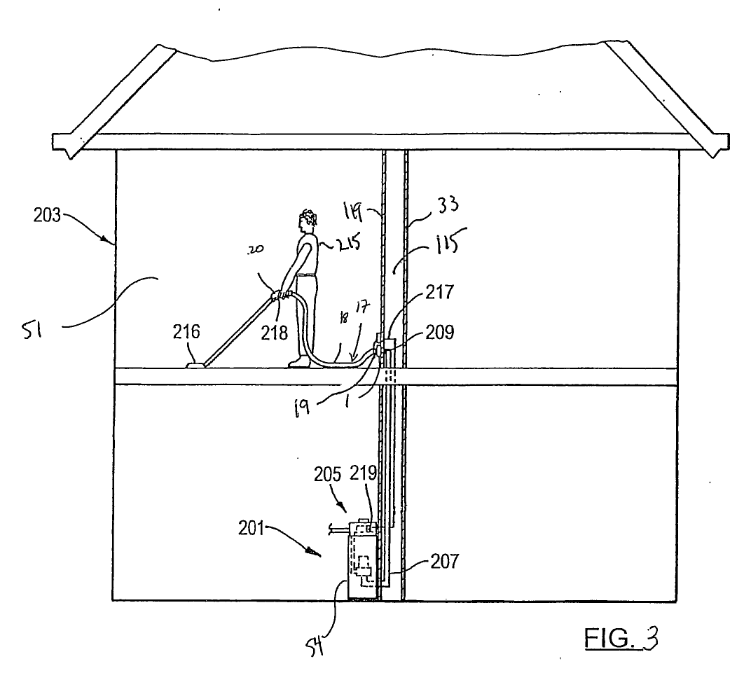

Referring to FIG. 3, the wall valve 1 is used in association with a flexible central vacuum cleaning system hose assembly 17 that has a flexible hose 18, a hose nipple 19 and a handle 20. The hose 18 and handle 20 are clearly shown in FIG. 3, while hose nipple 19 is only clearly evident in detailed FIGS. such as FIGS. 1 and 2. It is to be understood that the hose nipple 19 and hose 18 are connected, for example, in a manner such as those currently known in the art. The wall valve 1 and hose assembly 17 are for use in a central vacuum system, such as system 201. The system 201 is installed in a building 203. The building 203 is shown as a residence; however, the system 201 could be installed in other buildings, such as commercial or industrial buildings.

The system 201 has a vacuum source 205 in a central location. The source 205 is connected through pipes 207 or other conduits in walls, floors or ceilings of the building 203. Alternatively, the pipes 207 may be exposed. The pipes 207 terminate at valve 1 to which a hose assembly 17 may be connected through hose nipple 19. The hose assembly 17 terminates in handle 20 that is held by an operator 215. Various cleaning attachments, such as a carpet brush 216, are connected to the handle 20.

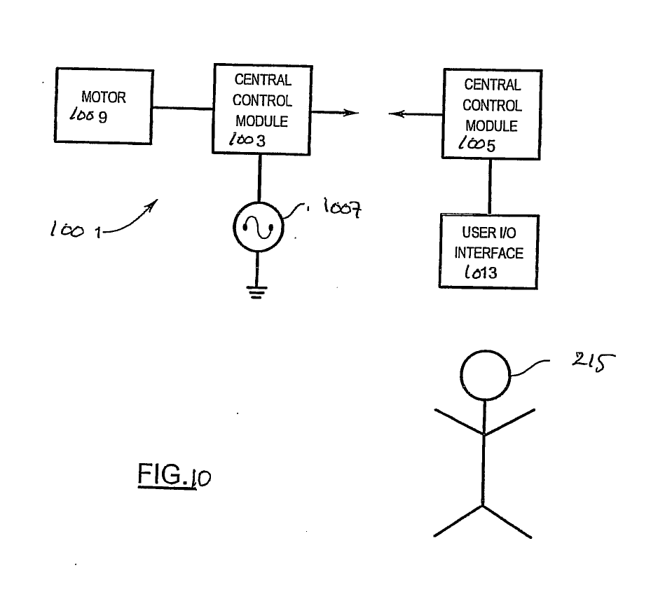

Control signals, such as ON/OFF, from the operator 215 are provided through a switch 218 (or switches 218) or some other interface in the handle 20. More sophisticated systems 201 may utilize the control signals for many other purposes, such as duplex communications that allow the receipt of information at the handle 20. Such information could be used to drive LEDs or other display means 1021 (see FIG. 11) for communication with the operator 215. When the operator 215 turns on the system 201, dirt is drawn by a vacuum created by the vacuum source 205 through the attachment 216, handle 20, hose assembly 17, wall valve 1, and pipes 207.

Referring to all the FIGS., the hose nipple 19 has an external contour that fits through the opening 10 of the conduit 7. Insertion of the hose nipple 19 into the conduit 7 against front surface 21 of valve member 5 causes the valve member 5 to slide to position B leaving open the aperture 13. The hose nipple 19 has an aperture 22 corresponding to the aperture 13. The hose nipple 19 has a longitudinal axis 22a and the aperture 22 opens out of line with the axis 22a to permit mating of the aperture 22 and the aperture 13.

Mating of the apertures 13, 22 provides fluid communication, and a flow path, through the wall valve 1 from the hose assembly 17 to the aperture 13. A push-in valve 1 provides for easy insertion of the hose nipple 19 as it is not necessary to open the wall valve 1 separately from insertion of the hose nipple 19 as is the case with standard wall valves that have an outward opening spring-loaded door.

The wall valve 1 also has a wall plate 23. The wall plate 23 has an aperture 25 through which the hose nipple 19 extends into the conduit 7. Extending from an external surface 27 of the conduit 7 perpendicular to the axis 11 is a flange 29, the wall plate 23 provides a flange surface 31 opposite a portion of the flange 29. The flange 29 and flange surface 31 are connected to one another such that a wall surface 33 (the wall valve 1 extends through an aperture 34 in wall surface 33) can be tightly retained between the flange 29 and the flange surface 31.

In the preferred embodiment the flange 29 and flange surface 31 are connected through corresponding threads 35 on the external surface 27 and threads 37 on an internal surface 39 of the aperture 25. The wall plate 23 is easily mounted to the conduit 7 by threading the wall plate 23 onto the conduit 7. An o-ring 41 is provided in the preferred embodiment about the conduit 7 between the threads 35 and the flange 29. The o-ring 41 fills a space 43 between an end 44 of the wall plate 23 that extends into the aperture 34 in the wall surface 33, the external surface 27 on the conduit 7, the flange 29, and an interior surface 45 of the wall surface 33 about the aperture 34. The o-ring helps to provide an air seal between the conduit 7 and the wall plate 23 in case the seal between the apertures 13, 22 is leaky. A fastener, such as for example glue, screws or a locking tab, could be used to prevent the wall plate 23 from unthreading.

The valve member 5 has two opposing ends 47, 49. End 47 is closed. End 47 substantially encloses opening 10 when valve member 5 is in position A. This can provide a pleasing finish for the wall valve 1 when viewed from a room interior 51. As valve member 5 seals aperture 13 it is not necessary for the valve member 5 to provide a seal at opening 10.

A spring 53 or other resiliently loaded mechanism maintains the valve member 5 in the first position A. The force of the spring 53 is set to be overcome upon manual insertion of the hose nipple 19 to cause the valve member to move to position B. This exposes the aperture 13 to the hose nipple 19 and aperture 22. When the apertures 13, 22 are mated fluid communication, and a fluid flow path, is created between the hose nipple 19 and the aperture 13 as discussed previously. If desired, additional locking means could be added to lessen the possibility that the valve member 5 could be inadvertently moved to expose the aperture 13. Such locking means could be set to open only when a corresponding hose nipple 19 is inserted into the wall valve 1.

When the hose nipple 19 is removed from the conduit 7, the spring 53 returns the valve member 5 from position B to position A. This again closes the aperture 13. Suction from central vacuum source 205 will further draw the valve member 5 against about the aperture 13 to seal the aperture 13.

The spring 53 is located between the end cap 8 and the valve member 5. The end cap 8 has a post 55 extending into the conduit 7. The valve member 5 has a post 57 extending inside end 47. The post 57 has a central bore 59 into which the post 55 can extend. The spring 53 is retained by the respective posts 55, 57 between the end cap 8 and valve member 5.

Longitudinal extension 61 of valve member 5 extends from end 47 to end 49. The longitudinal extension provides a sealing surface 63 over the aperture 13 when the valve member 5 is in closed position A.

The conduit 7 has a keyway 65 into which a key 67 extends from the longitudinal extension 61. Keyway housing 68 is shown in some of the FIGS. The key 67 meets the second stop surface 16 to provide a stop for the longitudinal location of the valve member 5 for position A mentioned previously. The key 67 and keyway 65 also provide rotational alignment of the valve member 5 with respect to the conduit 7 about the axis 11 to ensure that the sealing surface 63 aligns with the aperture 13 when in position A.

The valve member 5 has a second keyway 69 to permit rotation of the valve member 5 while in position B and also to prevent the valve member 5 from returning to position A when the key 65 is in the keyway 69. This locks the valve member 5 so that the spring 53 and valve member 5 do not tend to force the hose nipple out of the wall valve 1 when in use.

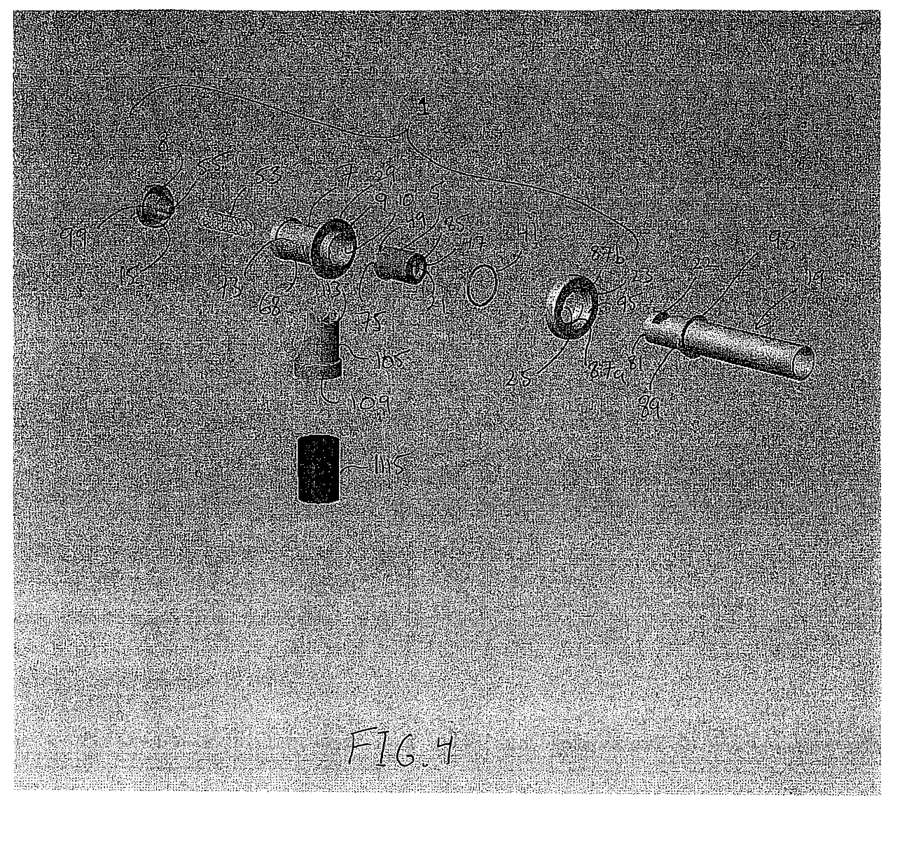

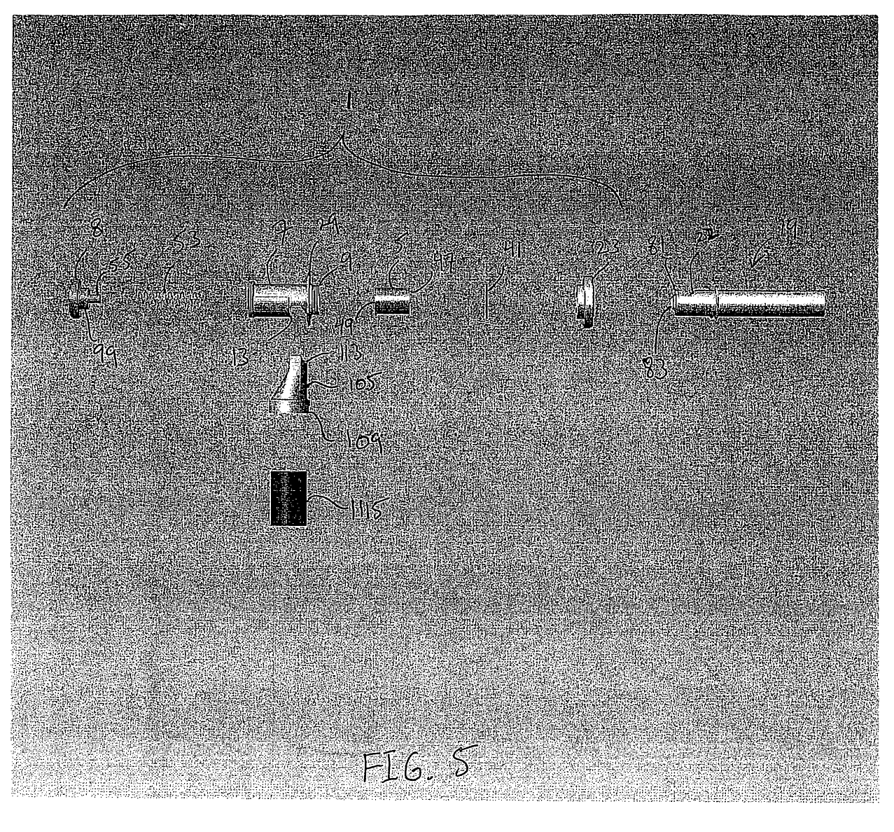

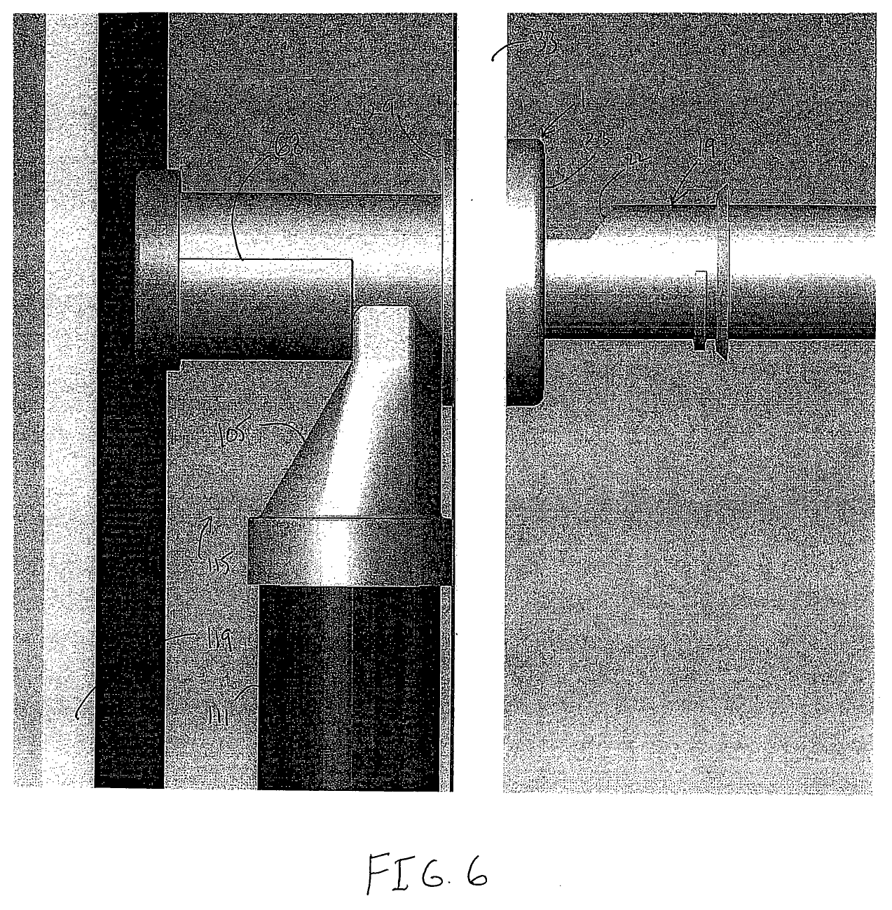

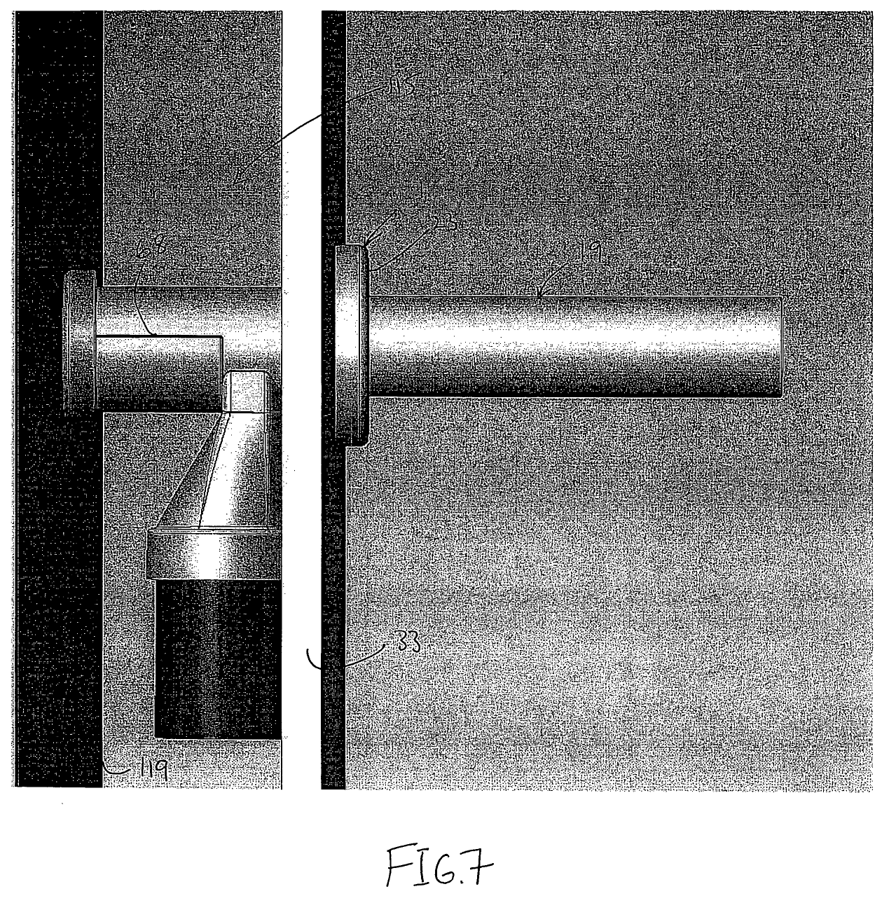

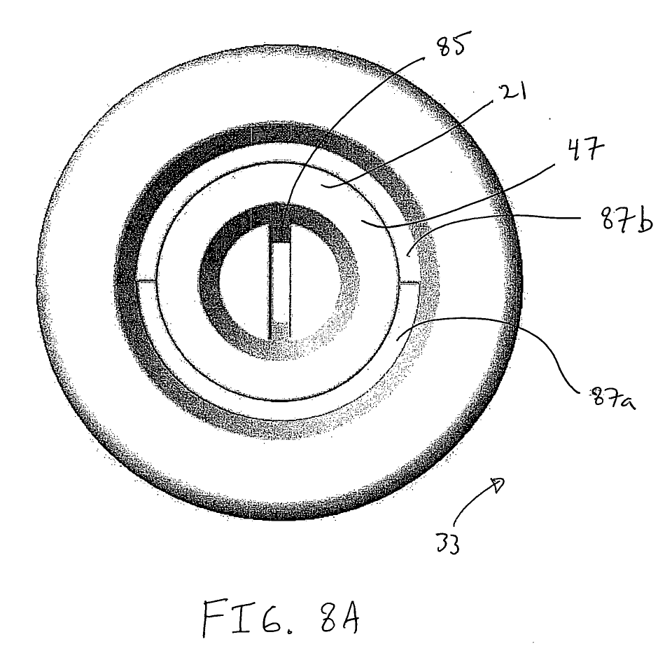

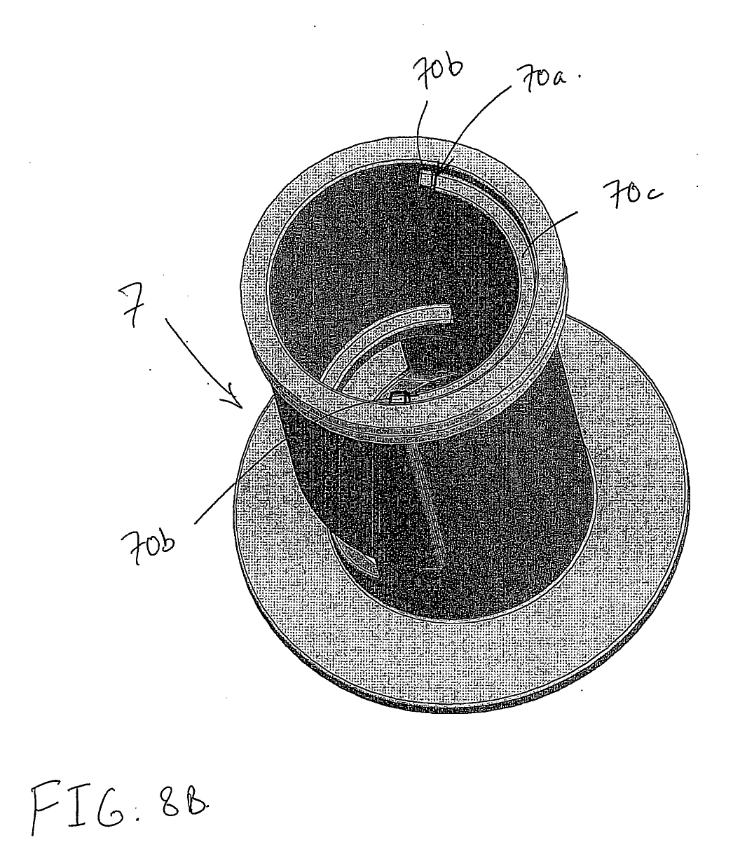

The key 65 and keyway 67 have corresponding rotational stop surfaces 75 and 71 (FIG. 1), 73 (the outside of which is shown in FIG. 4) to provide rotational alignment of the valve member 5 when in position A. Referring to FIG. 8B, to provide rotational alignment of valve member 5 and the conduit 7 when in position B, and to prevent the valve member from undesired rotation when in position B, a locking mechanism 70a such as detentes 70b on either end of keyway 69. These allow the key 65 to drop into recessed surface 70c in the keyway 69 under pressure from spring 53. In this position the valve member 5 may actually come away slightly from the end 47 when the apertures 13, 22 are aligned. Pushing in the valve member 5 will again allow for its rotation. As will be evident to those skilled in the art, locking mechanism 70a can take many other forms, or may be replaced, for example, by a mechanism that provides a positive indication of location, such as a small boss and corresponding indentation combination that allows the operator 15 to sense alignment of the apertures 13, 22 and release the nipple 19.

Contrary to existing hose nipples, hose nipple 19 is closed at distal end 81. The distal end 17 has an outwardly extending key 83 and the valve member 5 end 47 has an opposing key slot 85. Engagement of the key 83 and key slot 85 provides rotational alignment of the hose nipple 19 and valve member 5 and rotational coupling that fixes the relative rotational position of the hose nipple 19 and the valve member 5. The coupling also enables rotation of the hose nipple about the axis 11 to cause rotation of the valve member 5 when in position B such that the key 65 can rotate into and out of the keyway 69. The key 83 is a first rotational coupling mechanism and the key slot 85 is a second rotational coupling mechanism that together form the rotational coupling. When the key 65 aligns with keyway 67 the spring 53 will tend to push the valve member 5 toward position A. The rotational coupling is manually engageable and manually releasable. The rotational stop surfaces 71, 73, 75 provide a positive indication of the rotational alignment of the valve member 5 to an operator through the hose nipple 19.

The wall plate 23 has first and second semi-annular flanges 87a, 87b about the aperture 25. One flange 87a is longitudinally behind the other, while the flanges rotationally oppose one another. The hose nipple 19 has a corresponding semi-annular flange 89 about its outer surface 91. The flanges 87a, 87b, 89 are aligned such that initial engagement is only permitted when the nose nipple 19 is aligned such that the aperture 25 is in rotational position ultimately to be seated about the aperture 13 after insertion and rotation. In the preferred embodiment the flanges 87a, 87b, 89 only initially engage when the aperture 25 opens rotationally opposite to the aperture 13. If the hose nipple 19 is not in this position then the hose nipple 19 is prevented from full insertion into the valve 1 and rotation of the hose nipple 19 is prevented because the key 67 will not be in position to enter the keyway 69. If the hose nipple 19 is released by the operator 215 then the spring 53 will simply push the hose nipple 19 out of the wall valve 1.

The flanges 87a, 87b, 89 also provide asymmetric rotationally alignment to ensure that the aperture 25 is not 180 degrees out of alignment with the aperture 13 because the key 83 was inserted into the key slot 85 upside down. This alignment could be incorporated into the key slot 85 and key 83 by providing asymmetric alignment, for example, one part of key 83 and key slot 85 extending further from the axes 11, 22a then another. As a further alternative, the key 83 and key slot 85 could be replaced by another manually engageable coupling such as a plurality of respective pins and holes on the valve member 5 and the hose nipple 19 that are equally spaced about the longitudinal axes 11, 22a. The pins and holes could provide full asymmetric alignment by utilising on alternative spacing arrangement. Other manually engageable couplings for fixed rotational movement will be evident to those skilled in the art based upon the principles described herein.

When the hose nipple 19 is inserted into the conduit 7, the hose nipple 19 can be rotated such that the flange 89 is longitudinally between the flanges 87a, 87b. If the hose nipple 19 is pulled longitudinally out of the wall valve 1 then the flange 89 will engage the flange 87b and the longitudinal motion will be prevented.

The flanges 87b, 89 prevent the hose nipple 19 from inadvertently disengaging from the wall valve 1 during use. The flanges 87b, 89 are respective longitudinal retention mechanisms that in combination releasably retain the hose nipple 19 in the wall valve 1 against longitudinal movement during use. Such movement might otherwise occur if the hose assembly 17 tends to pull the hose nipple 19 from the wall valve 1 when the hose assembly 17 is in use during cleaning.

Rotational alignment mechanisms on the conduit 7 and the wall valve 1 provided by keyway 65 and key 67 in combination with rotational alignment mechanisms on the valve member 5 and the hose nipple 19 provided by the key slot 85 and key 83 provide combined rotational alignment mechanisms to align the hose nipple 19 with the wall valve 1 for insertion of the hose nipple 19. If the hose nipple 19 is required to be rotated during insertion 1 such as described herein for engagement of the longitudinal retention mechanisms then additional rotational alignment mechanisms such as the keyway 69 and stop surfaces 71, 73, 75 and positive alignment indicators 70a can be used to ensure rotational alignment of the hose nipple 19 while the valve member 5 is not in the open Position B.

The hose nipple 19 has an outwardly extending flange 93 about its circumference. The wall plate 23 has an external groove 95. The flange 93 and groove 95 provide respective stop surfaces to limit the distance that the hose nipple 19 can be inserted into the conduit 7. The flange 93 and groove 95 can also provide a secondary seal to the aperture 13/aperture 22 seal, or a primary seal if desired.

Different depths of wall plate 23 could be provided for different wall surface 33 thicknesses. For example, standoff section 98 of wall plate 23 could have different depths, be customizable, or be adjustable to allow for differing thickness of wall surface 33 while maintaining the relationship between the aperture 13 and flanges 87a,b such that the hose nipple 19 does not need to be changed. The end cap 8 has an outwardly extending post 99 coaxial with the post 55. An external surface 101 of the post 99 engages an internal surface 103 of the longitudinal extension 61 to provide positive alignment of the valve member 5 about the axis 11. This also assists in maintaining proper alignment of the valve member 5 and conduit 7 about the aperture 13 to ensure a proper seal.

Although it is not necessary for all features, it is advantageous for the longitudinal portions of the components of the wall valve 1 and hose nipple 19 to be generally cylindrical. This is particularly true when it is desired to use rotational features such as the rotational locking of the valve member 5 when in position B and the rotational locking of the hose nipple 19. In the preferred embodiment as shown in the FIGS. the components of the wall valve 1 and hose nipple 19 are generally cylindrical. Those features that are not fully rotationally symmetrical can result in limited non-cylindrical characteristics.

An adapter 105 fits into the aperture 13. The adapter 107 has a first port 109 that mounts to a standard vacuum system wall pipe 111. The adapter 107 has an opposing second port 113 that matches the exterior contour of the valve member 5 about the sealing surface. The adapter 107 is typically glued to the wall pipe 111. The adapter 107 fits within the aperture 13 and is secured thereby to prevent lateral movement of the adapter 107 relative to the conduit 7. The adapter 107 may be glued to the conduit 7; however, this is not necessary.

The aperture 22 is also sized to seal against the port 113. This is advantageous as the fluid path then extends through the hose nipple 19 directly to the adapter 105. This avoids having fluid or dust enter or become caught on the remainder of the conduit 7. Alternative sealing locations are available, including to the conduit 7 about the aperture 13. If this location is chosen in place of a seal to the adapter 105 then one will want to ensure that there is a permanent seal, such as by glue or the like, between the conduit 7 and the adapter 105. This may still not be preferred as dust or other matter may be pushed from the wall valve 1 when the hose nipple 19 is removed.

The wall valve 1 is intended for use within a wall cavity 115. In many homes standard North American construction provides a depth of 3½ inches between wall surface 33 and wall surface 119. This is when nominal 2 inch by 4 inch wall studs, not shown, are used. The invention is not limited to 3½ inch wall cavities; however, the preferred embodiment has been shown with this type of construction in mind. Typically the pipe 111 has a nominal diameter of 2 inches. As a result the aperture 13 is limited in size in order to provide sufficient travel for the valve member 5 to uncover the aperture 13.

The adapter 105 provides any required reduction in size between the port 109 and the port 113. The aperture 13 is placed immediately adjacent the flange 29 to provide more room for the aperture 13.

In the preferred embodiment the valve member end 47 is recessed into the wall plate 23 from the perspective of a user 215 in room 51. This shortens the depth of the valve member 5 and its required travel to uncover the aperture 13.

In the preferred embodiment the port 113 has an opening of approximately 1 inch by 1¼ inches. The narrower dimension is measured in the direction between wall surfaces 117, 119. The port 113 is also contoured to match the valve member sealing surface 63. In the preferred embodiment the contour is an arc about the axis 11. The reduction described herein has not been found to impact adversely the fluid flow. In fact the reduction can be advantageous as larger items inadvertently drawn into the wall valve 1 can be trapped and retrieved before being drawn into the pipe 111 where they may become stuck, or further into the central vacuum source 205 where they may be lost.

The hose nipple 19 has an external diameter of approximately 1½ inches as is typical for hose nipples used in central vacuum cleaner systems. Other diameters could be used. Given the number of points of contact, including the sealing surface 63, the key slot 85, and the flanges 87b, 89, the hose nipple 19 does not have to fit snugly against the conduit 7; however, it is preferable that contact between the outer surface of the hose nipple 19 and the conduit 7 is maintained to provide a good seal, provided that the hose nipple 19 can be rotated by an operator 215 for alignment. As mentioned previously, alternative sealing locations are possible.

The push-in front surface 21 of wall valve 1 provides for one-step insertion of the hose nipple 19.

Again, it is not necessary to utilize all of the elements of the wall valve 1 and hose nipple 19 in order to gain benefits from the principles described herein, for example the push in front surface 21 of wall valve 1 can be utilized with a corresponding hose nipple 19 for a direct insertion of the hose nipple 19 into the wall valve 1 and without utilizing the twist lock features described previously.

In such a configuration the front surface 21 of wall valve 1 is still solid to prevent entry of dust and other substances when the wall valve 1 is in a closed position. The hose nipple 19 continues to have a solid distal end 81 with an aperture 22 out of line with the longitudinal axis of the hose nipple 19.

Alternative wall valve 1 configurations are possible. For example, for larger cavity 115 thicknesses the aperture 13 and the port 113 may have larger sizes. This will result in a larger valve member 5 to cover the aperture 13.

Referring to FIG. 3, the wall valve 1 is particularly well suited for use in association with a stretch hose as the hose 18. Stretch hoses are well known in the vacuum cleaner industry; however, stretch hoses have seen limited use in central vacuum cleaning systems. Stretch hoses are used primarily in association with mobile upright vacuum cleaners; however, stretch hoses are available for central vacuum cleaner applications.

The wall valve 1 prevents inadvertent release of a stretch hose 18 from the wall valve 1 that could otherwise be caused by the inherent tension in a stretch hose 18 when fully extended in use.

Such inadvertent release is exacerbated as a stretch hose 18 extension ratio increases. Stretch hoses for the purpose described herein are available from Smiths Flexible Technologies Division P. O. Box 88, 528 Carwellyn Road, Abbeville, S.C. 29620. Current available extension ratios are 2:1, 3:1, 4:1, 6:1, and 8:1. It is anticipated that even higher extension ratios will be available over time.

A stretch hose 18 provides the benefit of reduced size when not extended such as during storage or when carrying from one wall valve to another. Also, a stretch hose 18 will typically have reduced weight over a non-stretch hose.

A suitable hose nipple 19 will need to be added to a stretch hose 18, as will a handle 20, to create hose assembly 17.

Again, it is not necessary to utilize all of the elements of the wall valve 1 and hose nipple 19 in order to gain benefits from the principles described herein, for example a hose nipple 19 used in association with a stretch hose assembly 17 could be used with a wall valve 1 that is not a push-in type, but where the hose nipple 19 and the wall valve 1 have longitudinal retention mechanisms. For example, wall valve 1 and hose nipple 19 could have respective flanges 87a, 87b, 89 to prevent respective longitudinal movement during use. The flanges 87a, 87b, 89 are rotationally engaged during insertion of the hose nipple 19.

Referring to FIG. 9, it has been recognized that large lengths of stretch hose, such as the 20-30′ extended lengths that are encountered in central vacuum cleaning applications, can be cumbersome to carry and to prepare for storage as the stretch hose 18 tends to extend when it cannot be gathered and picked up all at once. One solution is to provide a non-stretch hose conduit 104 of greater diameter than the external diameter of stretch hose 18.

The conduit 104 contains stretch hose 18 when stretch hose 18 is not extended. Stretch hose 18 extends from the conduit 104 when in use. The conduit 104 provides a container for the stretch hose 18. The conduit 104 can be easier to carry and to prepare for storage than a stretch hose 18 without the conduit 104.

The wall valve 1 can be used in association with such a stretch hose 18/conduit 104 combination. The conduit 104 can be fixed at hose nipple end 106 of the stretch hose 18 or at the handle end, not shown. Fixing the conduit 104 at the hose nipple end 106 is preferable as most of the weight of the conduit 104 is not held by the user 215 when in use.

In order to provide the full features of a modern central vacuum cleaning system, the wall valve 1 and hose nipple 19 can be provided with electrical contacts for providing wired remote control connections between the handle 104 and the central vacuum source 205. A stretch hose 18 would need to carry wires to provide connection between the handle 20 and the hose nipple 19. Standard in-wall wiring could connect between the wall valve 1 and the source 205.

Alternatively, wireless remote control could be employed. For example, an acoustic remote control could be used. An example of an acoustic remote control is described in U.S. Pat. No. 5,924,164 issued Jul. 20, 1999 to Edward W. Lindsay under title ACOUSTIC COMMUNICATOR FOR CENTRAL VACUUM CLEANERS, the content of which is hereby incorporated by reference into the detailed description hereof.

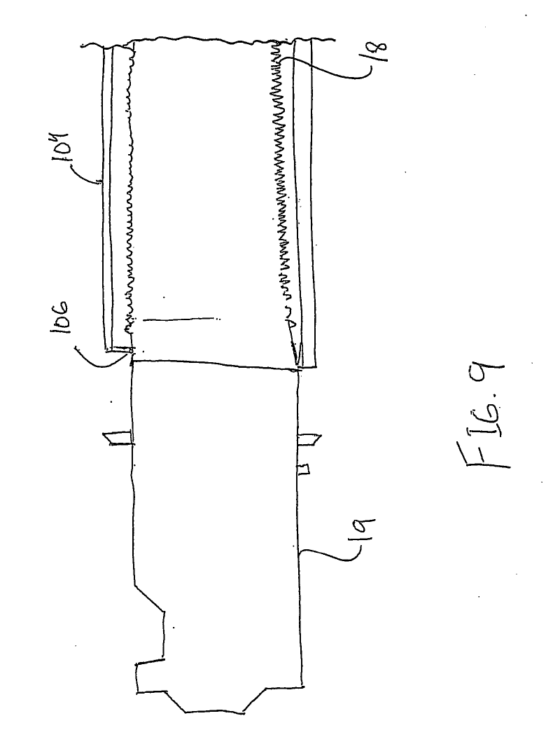

Referring to FIG. 10, as a further alternative, radio frequency wireless remote control may be used. For example, a central vacuum cleaning system control subsystem 1 has a central control module 1003 and a remote control module 1005.

The central control module 1003 controls power from a power source 1007 to a motor 1009, and by doing so the central control module 1003 controls the operation of the motor 1009. The power source 1007 is typically line voltage, for example, 120V or 240V, 60 Hz AC in North America or 230V, 50 Hz AC in Europe.

The remote control module 1005 is connected to a user input/output interface 1013. The remote control module 1005 receives input from an operator 215 through the interface 1013. User input may be as simple as a request for a change of state of the motor 1009 where the interface 1013 would be a toggle switch 13.

The remote control module 1005 is a wireless transmitter. It encodes the input received from the user for wireless transmission to the central control module 1003 as indicated by the arcs 1015. The central control module 1003 is a wireless receiver. It receives the wireless transmission from the remote control module 1005, decodes it and controls the motor 1009 accordingly. For example, if the user requests the motor 1009 to change state then if the central control module 1003 is providing power from the source 1007 to the motor 1009 then the central control module 1003 will cease doing so. If the central control module 1003 is not providing power from the source 1007 to the motor 1009 then it will provide power.

The central control module 1003 is also a wireless transmitter. The central control module 1003 senses the operating condition of the motor 1009, encodes a message related to the condition and wirelessly transmits the message to the remote control module 1005 as indicated by the arcs 1017. The message is received by the remote control module 1005, decoded, and provided to the user through the interface 1013.

Referring to FIG. 11, a hose handle 20 incorporates the interface 1013 as a display means 1021 and switch 1023. A toggle switch 1023 is shown in the FIGS.; however, various types of switches, such as for example a momentary switch, not shown, could be used. The display means 1021 may take the form of one or more lights, such as LEDs and/or an LCD screen with icons. Alternatively, or in addition, the display means may have a speaker or buzzer to provide sound output to the user by way of voice or an alarm. A transducer may be used to create sounds. This provides bi-directional communication between the central control module 1003 and the remote control module 1005, and thereby provides bi-directional communication between the operator 215 and the motor 1009 as will be discussed further herein.

In a preferred embodiment, the central control module 1003 is able to provide more complex control of the motor 1009 beyond simply turning it on and off. For example, the central control module 1003 may be able to adjust the speed at which the motor 1009 operates. There are many different techniques for adjusting motor 1009 speed, some of which are dependent on the type of motor 1009.

Additional features that may be incorporated into a RF wireless remote control system are described in co-pending U.S. patent application Ser. No. 10/936,699 entitled CENTRAL VACUUM CLEANING SYSTEM CONTROL SUBSYSTEMS filed Sep. 9, 2004, the content of which is hereby incorporated by reference into the detailed description hereof.

The benefits of a RF wireless remote control are numerous, particularly where a stretch hose 18 is used. As a stretch hose 18 is not required to carry wires, stretch hose 18 can be relatively inexpensive and lightweight, and can have a relatively high extension ratio. Wires are also not required to be installed in the walls.

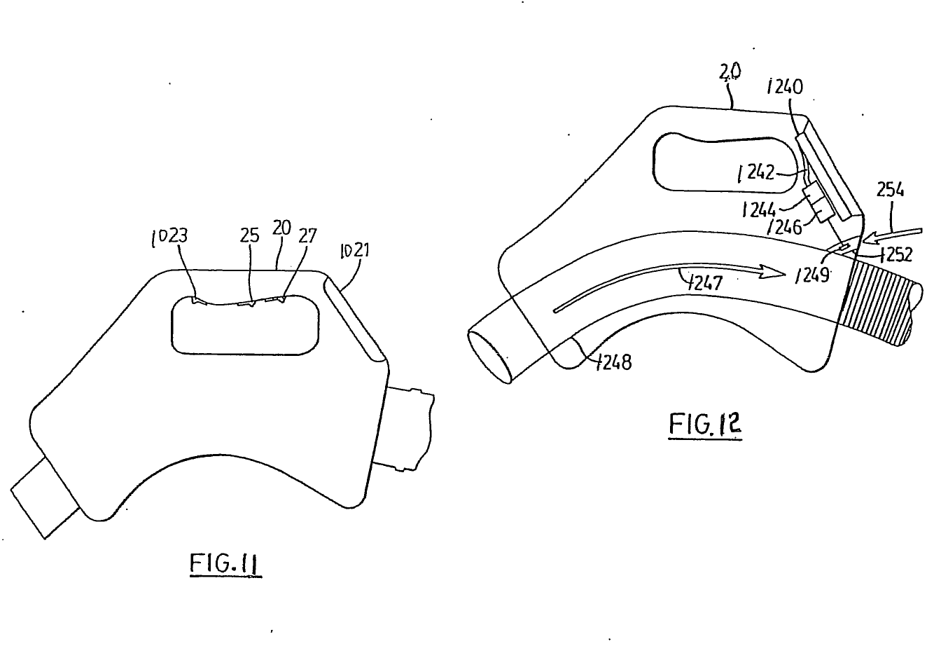

Referring to FIG. 12, in a manner similar to that described for the central control module 1003, the remote control module 1005 is mounted in a handle, for example handle 20, typically on a printed circuit board 1240. It is to be noted that other handles, such as for example handles 20, 213 could be used. The printed circuit board 1240 and other components of the central control module 1003 could be fully encapsulated with simply a couple of wires 1242 extending for connection to a power source 1244. Messages are provided to the operator 215 through display means 1021.

The remote control module 1005 is preferably battery 1244 powered; however, it may also be powered from line voltage where it is available, using a drop down resistor and capacitor. As mentioned previously, hose assembly 17 could have line voltage that could be used to power hose attachments 216, such as a power carpet brush. The battery 1244 can be a rechargeable battery 1244. Batteries 1244 provide energy for limited durations. This duration for a rechargeable battery 1244 is typically far shorter than that for a non-rechargeable battery 1244. In order to avoid having to frequently change the battery 1244, the battery 1244 could be a rechargeable battery 1244 that is recharged by using a generator 1246 powered from vacuum air (arrows 1247) flowing through the handle 20 to produce electrical energy. The generator could be powered by a turbine 1249 that extends into vacuum air path 1248. The turbine 1249 will turn, causing the generator 1246 to produce current for recharging the battery 1244. The generator 1246 will typically produce alternating current that would require an AC/DC converter and/or other battery charging circuitry 1250 for charging the battery 1244. The voltage may need to be stepped-up in order to provide sufficient voltage for charging the battery 1244. Many designs for such converters, including step-up converters, are readily available and could be used for this purpose.

To avoid damage to the turbine 1249 from passing dust particles, a separate turbine air path 1252 can be provided for the turbine 1249. The turbine air path 1252 extends from the vacuum air path 1248 through the handle 20 to allow ambient air 1254 to be drawn in through the turbine air path 1252 to the vacuum air path 1248. The motion of the ambient air 1254 flowing through turbine air path 1252 causes the turbine 1249 to turn. The motion of the turbine 1249 then powers the generator 1246. As an example, the turbine air path 1252 could be a one-quarter inch hole.

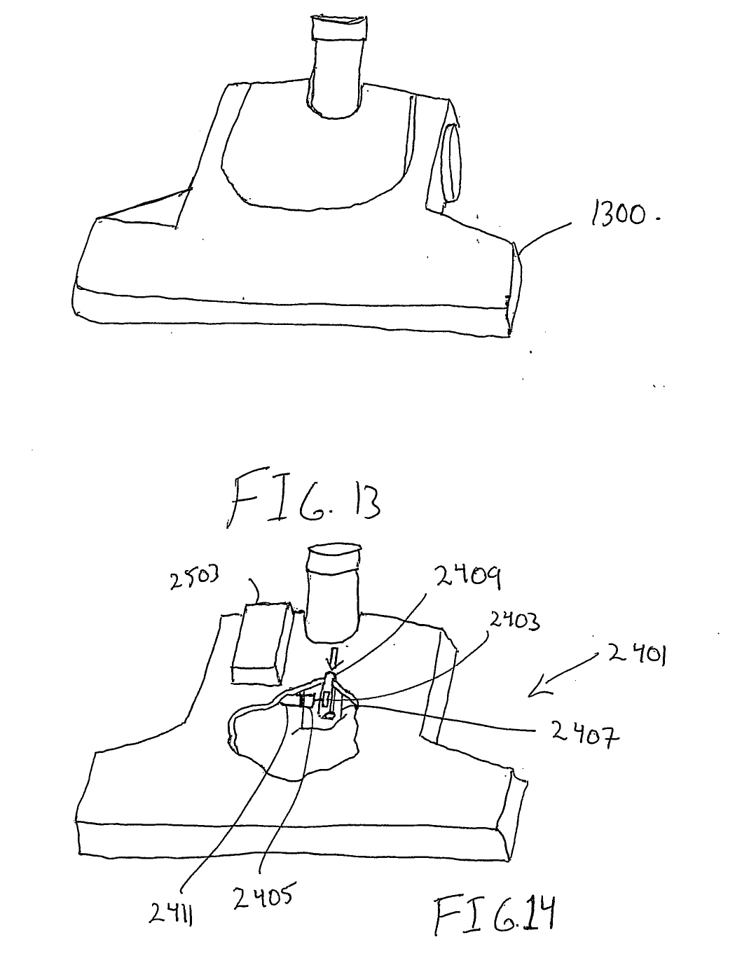

Referring to FIG. 13, where a wireless hose is employed, whether or not such hose is a stretch hose 18, powered cleaning attachments 1300 such as those with moving components, including for example brush rolls, beater bars, and brush roles with beater bars can be used in central vacuum cleaning system 201.

The attachment 1300 can be a turbine driven moving component central vacuum cleaning system attachment 1300 to provide a central vacuum cleaning system that does not require any wires (communication or power) to be provided in the hose assembly 17. The motive force for a turbine driven attachment is fluid flowing through the attachment.

Turbine driven components do not require electrical power to drive the moving components; however, electrically-powered accessories are generally preferred in the marketplace. An example of a turbine driven attachment 1300 is a TurboCat™ (TL2000) Air-Driven Vacuum Power Brush available from M.D. Manufacturing, Inc. of 300 Wood St., Bakersfield, Calif. 93307.

Referring to FIG. 14, alternatively, an electrically-powered attachment 2401 may be used. The electrically-powered attachment 2401 has a turbine 2403 and generator 2405. The turbine 2403 may be in a suction part 2407 of the attachment 2401, or as shown, in a separate turbine air path 2409.

The electrical power from the generator 2405 can be fed directly into a motor 2411 (show in block form in a random location with the attachment 2401) for driving a moving component in the electrically-power attachment 2401, such as a brush roll or beater bar.

It is desirable to use low amounts of energy to drive the electrically-powered attachment 2401 as the energy is being taken from the vacuum air flow, and reducing the effective suction through the electrically-powered attachment 2401. The use of a DC brush roll, such as that described in U.S. Pat. No. 6,848,147, of Charles D. Syverson et al. published Feb. 1, 2005 under title Internally Driven Agitator, would be an efficient design choice for the brush roller or beater bar 2413.

The electrically-powered attachment 2401 may be powered through a rechargeable battery 2503. The battery 2503 may be recharged between uses of the attachment 2401 by removing the battery 2503 and plugging it into a recharging station, not shown, for further connection to line power, or including a recharging circuit in the attachment 2401 such that the attachment 2401 can be connected directly to line power.

The battery 2503 may also be recharged during use of the power attachment 2401 by the turbine 2403 and generator 2405 in air path 2409. The energy generated by the generator 2405 can, for example, extend the operating time of the battery 2503 or allow for higher power consumption by the power attachment 2401 during use.

The electrically-powered attachments 2401 again allows for a wireless hose assembly 17. The electrically-powered attachments 2401 may be used in any central vacuum cleaning system. The electrically-powered attachments 2401 are particularly advantageous in connection with a handle 20 that utilizes wireless communication with the central source 205, such as the different RF configurations described herein.

This permits a central vacuum cleaning system that does not require any wires for connection between the handle 20 and the central source 205, or any power wires in the hose assembly 17. This results in a substantially lighter and less expensive hose. It also obviates the need for the installation of such wires and compliance with certain regulatory requirements, such as some safety circuitry, safety housings and regulatory approvals that are required in many jurisdictions when dealing with the voltages and currents involved in a line powered hose assembly and line powered attachments.

As the hose is the largest part of the system that must be moved about by the user, significant advantages result. In addition, RF wireless communication provides more robust and, if desired, feature-rich duplex communication than previous wireless communication systems, such as acoustic systems.

It will be understood by those skilled in the art that this description is made with reference to the preferred embodiment and that it is possible to make other embodiments employing the principles of the invention which fall within its spirit and scope as defined by the following claims. As an example, the various retention and alignment mechanisms can be reconfigured in many ways. It is possible to have the nipple cooperate with mechanisms on different elements of the valve. For example, the rotational alignment mechanism could be provided directly between the nipple and the conduit rather than indirectly through the valve member.

We claim:

1. A vacuum wall valve for use in association with a vacuum hose assembly having a hose nipple, the vacuum wall valve comprising:
a) an opening for receiving the hose nipple,
b) a valve member having a front surface, and
c) an aperture,
wherein the valve member is adapted for movement in the wall valve between a first position and a second position in response to insertion of the hose nipple through the opening and against the front surface,
wherein in the first position the front surface is between the opening and the aperture, the front surface substantially encloses the opening, and fluid connection between the opening and the aperture through the wall valve is prevented by the valve member, and
wherein in the second position the front surface is further into the wall valve in relation to the opening, and fluid connection is provided through the wall valve between the opening and the aperture.

2. The vacuum wall valve of claim 1 wherein the valve member is adapted for movement by sliding between the first position and the second position.

3. The vacuum wall valve of claim 1 wherein the valve member has a sealing surface, wherein the sealing surface seals about the valve aperture to prevent fluid connection between the opening and the aperture when the valve member is in the first position, and wherein the sealing surface is positioned away from the aperture to permit fluid connection between the opening and the aperture when the valve member is in the second position.

4. The vacuum wall valve of claim 3 wherein the hose nipple with which the valve is to be used has a longitudinal axis and an aperture in the hose nipple that opens out of line with the hose nipple longitudinal axis, and wherein the valve aperture is positioned to mate with the hose nipple aperture to provide sealed fluid communication between the valve aperture and the hose nipple.

5. The vacuum wall valve of claim 4 wherein the valve aperture opens generally perpendicular to the valve longitudinal axis.

6. The vacuum wall valve of claim 4 further comprising a valve alignment mechanism for receiving a corresponding nipple alignment mechanism on the hose nipple with which the valve is to be used, the alignment mechanisms in combination for aligning the hose nipple aperture and the valve aperture for mating.

7. The vacuum wall valve of claim 1 further comprising a first longitudinal retention mechanism for receiving a corresponding second longitudinal retention mechanism on the hose nipple, the retention mechanisms in combination for releasably retaining the hose nipple in the wall valve against longitudinal movement during use.

8. The vacuum wall valve of claim 7 wherein the retention mechanisms are engaged by rotational movement.

9. The vacuum wall valve of claim 8 wherein the retention mechanisms are corresponding flanges.

10. The wall valve of claim 1 further comprising a first rotational coupling mechanism for engagement with a second rotational coupling mechanism on the hose nipple, wherein engagement of the first rotational coupling mechanism and the second rotational coupling mechanism forms a rotational coupling between the valve and hose nipple, wherein the rotational coupling is manually engageable and manually releasable.

11. The wall valve of claim 6 wherein the valve alignment mechanism comprises a first valve alignment mechanism on the front surface.

12. The wall valve of claim 1 further comprising: a generally tubular conduit, wherein the opening is in one end of the conduit and an opposing end of the conduit is closed, wherein the aperture opens through the conduit but not at either of the ends, and wherein the valve member is adapted for movement in the wall valve by sliding within the conduit, and the first position and the second position are within the conduit.

13. The wall valve of claim 6 further comprising: a generally tubular conduit, wherein the opening is in one end of the conduit and an opposing end of the conduit is closed, wherein the aperture opens through the conduit but not at either of the ends, wherein the valve member is adapted for movement in the wall valve by sliding within the conduit and the first position and the second position are within the conduit, and the valve alignment mechanism comprises a first valve alignment mechanism on the front surface, and the nipple alignment mechanism is on the hose nipple.

14. The wall valve of claim 13 wherein the valve member and the conduit are adapted to permit rotation of the valve member within the conduit such that the valve aperture and the hose nipple aperture may be rotationally aligned.

15. The wall valve of claim 6 wherein the valve alignment mechanism comprises a first alignment mechanism on the front surface of the valve member corresponding to the nipple alignment mechanism, and a second alignment mechanism on the valve member and a corresponding third alignment mechanism on the conduit, wherein the nipple alignment mechanism and the first alignment mechanism in combination rotationally align the hose nipple and the valve member, and the second alignment mechanism and the third alignment mechanism in combination rotationally align the valve member and the conduit, whereby the valve aperture and the hose nipple aperture are rotationally aligned.

16. The wall valve of claim 15 wherein the second and third alignment mechanisms further comprise a positive indication of rotational alignment of the valve aperture and the hose nipple aperture.

17. The wall valve of claim 16 the second and third alignment mechanisms further comprise a locking arrangement to prevent undesired rotation of the valve aperture and the hose nipple aperture once the apertures are aligned.

18. The wall valve of claim 4 further comprising a first rotational alignment mechanism for alignment with a second rotational alignment mechanism on the hose nipple, wherein alignment of the first rotational alignment mechanism and the second rotational alignment mechanism is used to align the hose nipple aperture and the valve aperture.

19. A central vacuum cleaning system hose nipple for use in association with a central vacuum cleaning system wall valve, the hose nipple comprising:
a) a longitudinal axis,
b) a distal end,
c) and an aperture.
wherein the distal end is closed and in line with the longitudinal axis,
wherein the distal end is for insertion into the wall valve, and
wherein the aperture opens out of line with the longitudinal axis.

20. The hose nipple of claim 19 further comprising a first alignment mechanism for insertion against a corresponding second alignment mechanism on the wall valve with which the hose nipple is to be used, the alignment mechanisms in combination aligning the hose nipple aperture and a wall valve aperture on the wall valve for mating.

21. A central vacuum cleaning system hose assembly for use in association with a wall valve having a first longitudinal retention mechanism, the hose assembly comprising:
a) a hose nipple,
b) hose handle, and
c) a hose,
wherein the hose nipple is connected to a first end of the hose and the hose handle is connected to an opposing second end of the hose,
wherein the hose is a stretch hose, and
wherein the hose nipple comprises a second longitudinal retention mechanism for mating with the first longitudinal retention mechanism to releasably retain the hose nipple in the wall valve against longitudinal movement during use.

22. The hose assembly of claim 21 wherein the stretch hose is wireless and the handle comprises a radio frequency wireless transmitter.

23. The hose assembly of claim 22 wherein the handle further comprises a turbine and a generator, wherein the turbine is located such that air moving through the cleaning system during use will cause the turbine to turn, and wherein turning of the turbine causes the generator to generate electrical energy.

24. A central vacuum cleaning system comprising:
a) a central vacuum source,
b) a wall valve,
c) piping providing fluid communication between the wall valve and the vacuum source,
wherein the wall valve comprises an opening for receiving the hose nipple, a valve member having a front surface, and an aperture,
wherein the valve member is adapted for movement in the wall valve between a first position and a second position in response to insertion of the hose nipple through the opening and against the front surface,
wherein in the first position the front surface is between the opening and the aperture, the front surface substantially encloses the opening, and fluid connection between the opening and the aperture through the wall valve is prevented by the valve member, and
wherein in the second position the front surface is further into the wall valve in relation to the opening, and fluid connection is provided through the wall valve between the opening and the aperture.

25. A central vacuum cleaning system comprising
a) a central vacuum source,
b) a wall valve having an opening,
c) piping providing fluid communication between the wall valve and the vacuum source, and
d) a hose assembly,
wherein the wall valve comprises a first longitudinal retention mechanism
wherein the hose assembly comprises a hose, and a hose nipple at one end of the hose and a handle at another end of the hose,
wherein the hose is a stretch hose,
wherein the hose nipple has a second longitudinal retention mechanism,
wherein the first longitudinal retention mechanism is for receiving the second longitudinal retention mechanism during mating of the hose nipple and the wall valve, and
wherein the retention mechanisms in combination releasably retain the hose nipple in the opening of the wall valve against longitudinal movement during use of the cleaning system for cleaning.
